(19) United States
(12) Patent Application Publication
(10) Pub. No.: US 2026/0223236 A1
(43) Pub. Date: Jul. 30, 2026

(54) METHOD AND APPARATUS FOR SERVICE CONTINUITY IN A PERSONAL INTERNET-OF-THINGS (IOT) NETWORK (PIN)

(71) Applicant: INTERDIGITAL PATENT HOLDINGS, INC., Wilmington, DE (US)

(72) Inventors: Shalini Choudhury, Highland Park, NJ (US); Debashish Purkayastha, Eagleville, PA (US); Robert Gazda, Spring City, PA (US); Taimoor Abbas, Sainte-Julie (CA); Anuj Sethi, Ottawa (CA); Saad Ahmad, Montreal (CA); Michael Starsinic, Newtown, PA (US)

(73) Assignee: INTERDIGITAL PATENT HOLDINGS, INC., Wilmington, DE (US)

(21) Appl. No.: 19/102,610

(22) PCT Filed: Aug. 10, 2023
(86) PCT No.: PCT/US2023/029988

§ 371 Date: Feb. 10, 2025

Related U.S. Application Data
(60) Provisional application No. 63/396,838, filed on Aug. 10, 2022.

(51) Int. Cl. H04W 76/25; H04L 43/0811

(52) U.S. Cl. CPC H04W 76/25; H04L 43/0811

(57) ABSTRACT

Methods and apparatus for service continuity for personal IoT network (PIN) elements (PINEs) are described. A first message is received from a PIN server, including context information containing an identifier for a PINE, an identifier for a session for the PINE with an application server, and an identifier for a first PIN gateway (PEGC) providing 3GPP network services to the PINE for the session. A second message is received from the first PEGC, which indicates loss of connectivity with the PINE and includes the identifier for the PINE and the context information. It is determined that the PINE is authorized to connect to a second PEGC. The context information is updated to include an identifier for the second PEGC. A third message is sent to the second PEGC, which contains the identifier for the PINE, the updated context information and an indication to activate service continuity for the PINE.

### CROSS-REFERENCE TO RELATED APPLICATIONS

This application claims the benefit of U.S. Provisional Application No. 63/396,838, filed Aug. 10, 2022, the contents of which are incorporated herein by reference.

### BACKGROUND

The Internet of Things (IoT) has been designed for devices that communicate using the traditional cellular network. Devices with IoT capabilities may require better power consuming performance and increased network efficiency for bulk operations. When multiple IoT devices are deployed in a private environment, wireless transmit/receive units (WTRUs) with IoT capabilities may be organized in a personal IoT network (PIN).

### SUMMARY

Methods and apparatus for service continuity for personal IoT network (PIN) elements (PINEs) are described. A first message is received from a PIN server, including context information containing an identifier for a PINE, an identifier for a session for the PINE with an application server, and an identifier for a first PIN gateway (PEGC) providing 3GPP network services to the PINE for the session. A second message is received from the first PEGC, which indicates loss of connectivity with the PINE and includes the identifier for the PINE and the context information. It is determined that the PINE is authorized to connect to a second PEGC. The context information is updated to include an identifier for the second PEGC. A third message is sent to the second PEGC, which contains the identifier for the PINE, the updated context information and an indication to activate service continuity for the PINE.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a system diagram of an example home automation PIN;

FIG. 3 is a system diagram of an example system that makes use of wearable PINs;

FIG. 4 is a block diagram of an example personal IoT network architecture;

FIG. 5 is a block diagram of an example PIN Application (PINAPP) framework;

FIG. 6 is a signal diagram showing an example scenario where the PINE detaches from its current PIN gateway PEGC-1 and attaches to another PIN gateway PEGC-2;

FIG. 7A is a signal diagram showing an example of effecting service continuity;

FIG. 7B is a flow diagram of an example method of effecting service continuity;

FIG. 8 is a signal diagram of another example of effecting service continuity;

FIG. 9 is a signal diagram of another example of effectuating service continuity;

FIG. 10 is a signal diagram of another example of effectuating SC with simultaneous sessions enabled for the PINE; and

FIG. 11 is another signal diagram of an example of service continuity through the 5GS.

### DETAILED DESCRIPTION

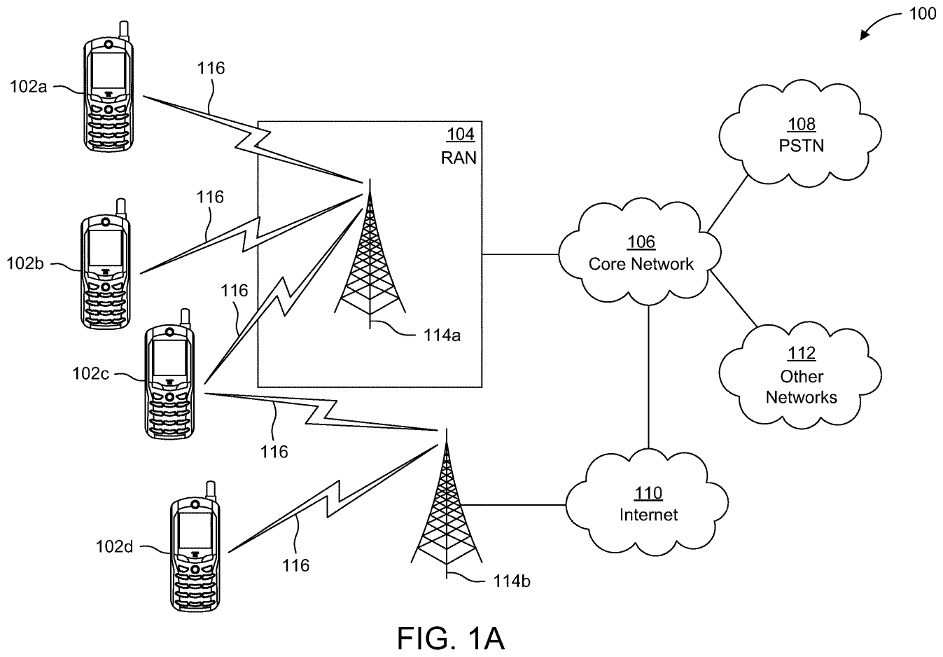

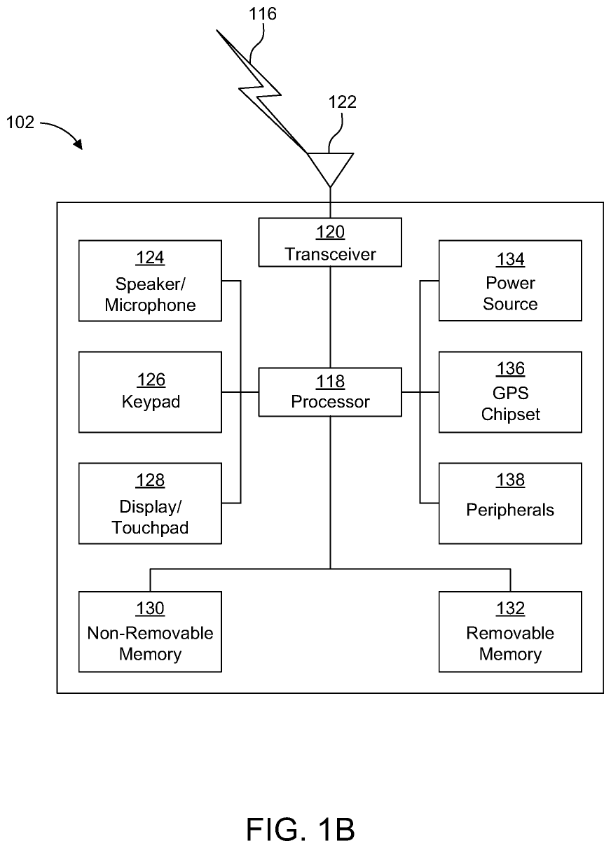

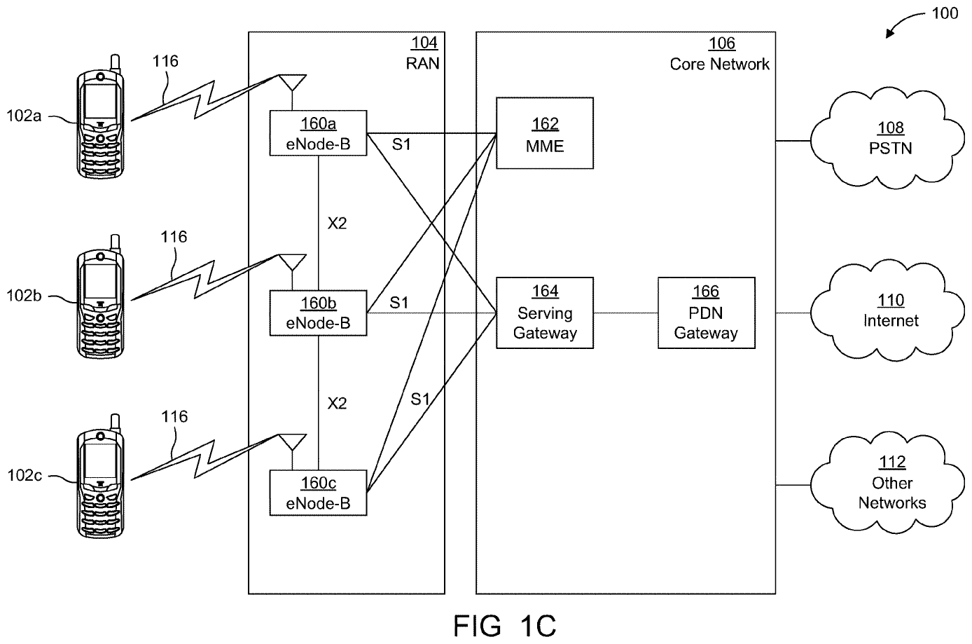

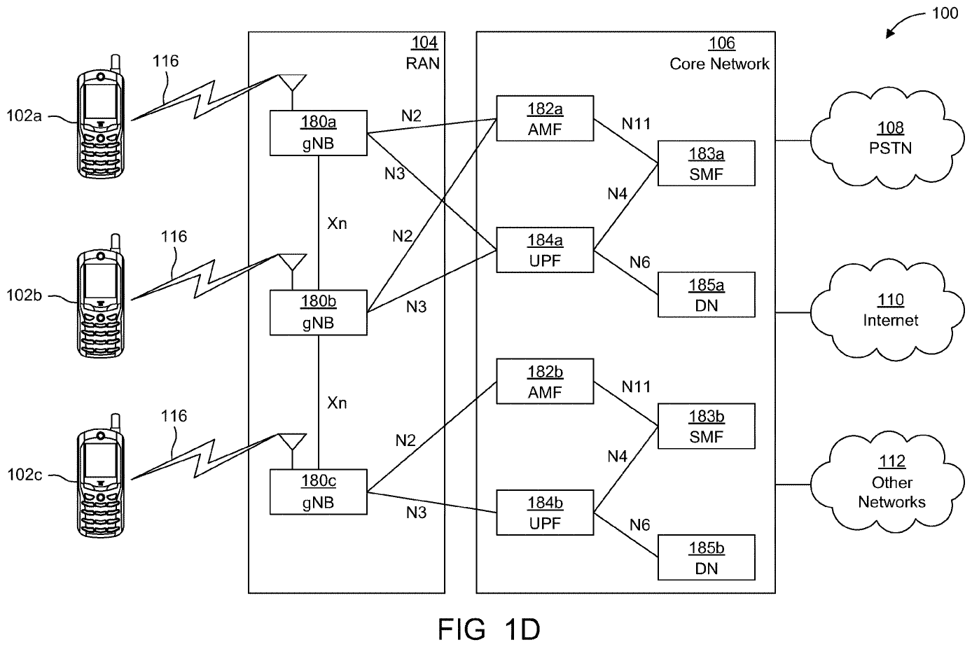

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

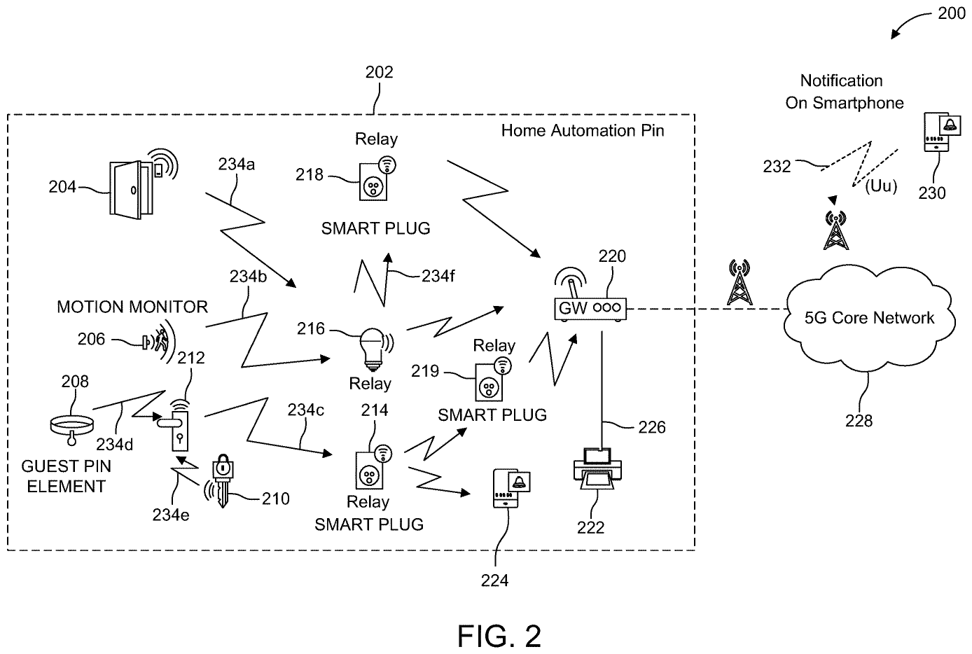

FIG. 2 is a system diagram 200 of an example system including a home automation PIN 202, which includes a number of IoT devices referred to as PIN elements (PINEs). In the example illustrated in FIG. 2, the PINEs may include a security sensor 204, a motion sensor 206, a guest PINE 208, a smart key 210, a smart lock 212, smart plugs 214, 218 and 219, a smart light bulb 216 and a smart phone 224. Such PINEs are typical of IoT devices used in home automation PINs.

Within the home automation PIN 202, each of the PINEs may communicate with one another, typically via non-3GPP communication, such as bluetooth or WiFi, and each of the PINEs may have different capabilities. For example, a residential gateway 220 may be a PINE with gateway capability and may provide wireless connectivity between a 3GPP network, such as a 5G Network, and the PINEs in the PIN 202. For another example, some PINEs may have relay capability to relay signaling from one PINE to another PINE within the PIN 202. In the example illustrated in FIG. 2, the security sensor 204 and the motion sensor 206 may send communications 234a and 234b, respectively, which may be relayed by the smart light bulb 216 to the residential gateway 220. The guest PINE 208 and the smart key 210 may send communications 234d and 234e to the smart lock 212. The smart lock 212 may send communication 234c, which may be relayed to the residential gateway 220 via the smart plug 219 and to the smart phone 224. The smart light bulb 216 may send communication 234f, which may be relayed by the smart plug 218 to the residential gateway 220. The printer 222 may communicate with the residential gateway 220 via an ethernet connection 226. The residential gateway 220, acting as a gateway between the PIN and the 5G Core Network 228, may send communications from the PINEs in the PIN 202 to the smartphone 230 via the Uu interface 232. A PINE may also be a PINE with management capability and may provide a means for an authorized administrator to configure and manage a PIN. For example, the residential gateway 220 in the PIN 202, which is acting as a PIN gateway, could support a PIN management function and be a PINE with management capability.

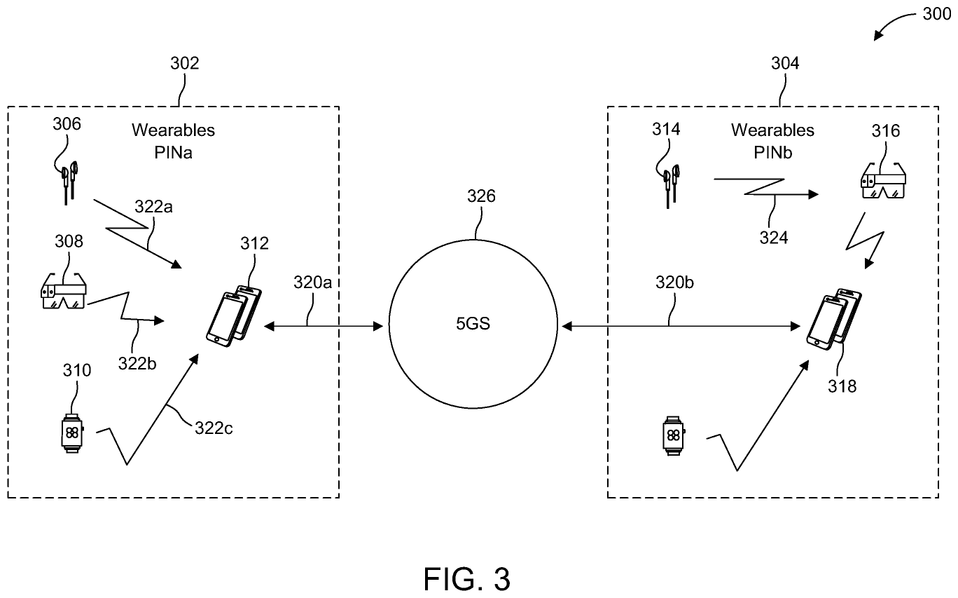

FIG. 3 is a system diagram 300 of an example system including wearable PINs 302 and 304. In the example illustrated in FIG. 3, two wearable PINs 302 and 304 each include ear buds 306, 316, virtual reality (VR)/augmented reality (AR) glasses 308, 316, and a smart phone 312, 318. The wearable PIN 302 also includes a smart watch 310. Similar to the home automation PIN 202 of FIG. 2, the PINEs (e.g., the ear buds, the VR/AR glasses, the smart phone and the smart watch in FIG. 2) may communicate with one another via non-3GPP communication, such as bluetooth or WiFi. In the example illustrated in FIG. 3, in the wearable PIN 302, the ear buds 306, the VR/AR glasses 308 and the smart watch 310 send communications 322a, 322b, and 322c, respectively, to the smart phone 312. The smart phone 312 may be configured with gateway capability (like the residential gateway 220 in the home automation PIN 202 of FIG. 2). The smart phone 312 may, thus, enable 3GPP/5G communication for the wearable PIN 302, acting as the gateway between the PINEs and the 3GPP/5G Core Network 326. In the wearable PIN 304, the ear buds 314 may send a communication 324, which may be relayed by the AR/VR glasses 316 to the smart phone 318. Similar to the wearable PIN 302, the smart phone 318 may be configured with gateway capability. The smart phone 312 may, thus, enable 3GPP/5G communication for the wearable PIN 304, acting as the gateway between the PINEs and the 3GPP/5G Core Network 326.

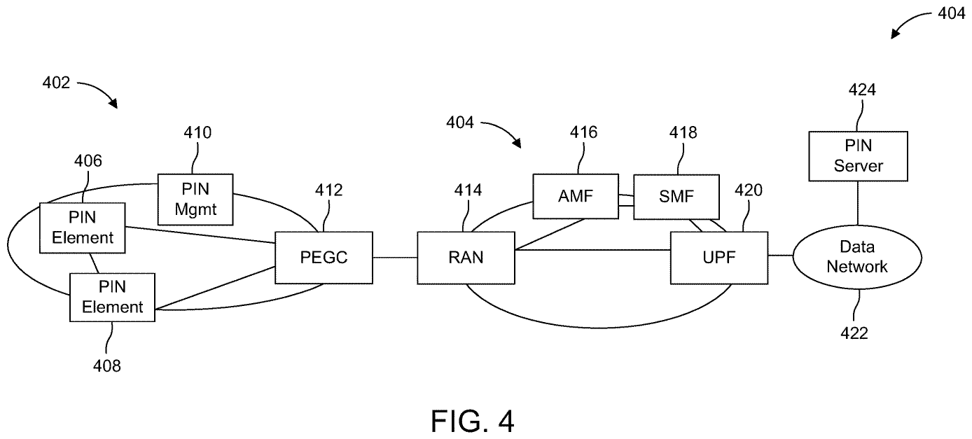

FIG. 4 is a system diagram of an example system including a PIN architecture 400. In the example illustrated in FIG. 4, the system includes a PIN 402 and a 5G Core Network 404. The 5G Core Network 404 may include a radio access network (RAN) node, which may communicate with the PEGC 412 to supply 5G connectivity to the PINEs 406, 408, as well as an access and mobility management function (AMF) 416 and a session management function (SMF) 418. The 5G Core Network 404 may also include a user plane function (UPF) 420, which may be used for communications with the data network 422.

Similar to the PINs illustrated in FIGS. 2 and 3, the PIN 402 includes a number of PINEs 406, 408, which may be a wireless transmit/receive unit (WTRU) or other non-3GPP device that may communicate with one another using non-3GPP communication, such as Bluetooth or Wifi. A PIN management device (PEMC) 410 may be included in the PIN 402 and may be provided with capability to manage the PIN 402. The PIN 402 may also include a PIN gateway (PEGC) 412 that may be configured to provide connectivity to and from the 5G Core Network 404 for other PINEs (e.g., the PINEs 406 and 408 in FIG. 4). PIN elements may communicate with each other via the PEGC 412 or directly. Additionally, the PINEs 406, 408 may communicate with the 5G Core Network 404 to obtain 5G services or communicate with a data network 422 via the 5G core network. In some embodiments, the PINEs 406, 408 may use the 5G Core Network 404 to obtain information from a PIN server 424 via the data network 424.

As per the 3GPP Release 18 Study on Personal IoT Networks, only PINEs with management capabilities and PINEs with gateway capabilities can be WTRUs. All other communications within the PIN may be carried out via non-3 3GPP communication, such as WiFi or Bluetooth.

3GPP SA6 is studying application layer support for PINs. Aspects of the study include application layer architecture requirements of a PIN, identifying key issues, and supporting the PIN application layer functional model. A PIN application (PINAPP) architecture has been proposed.

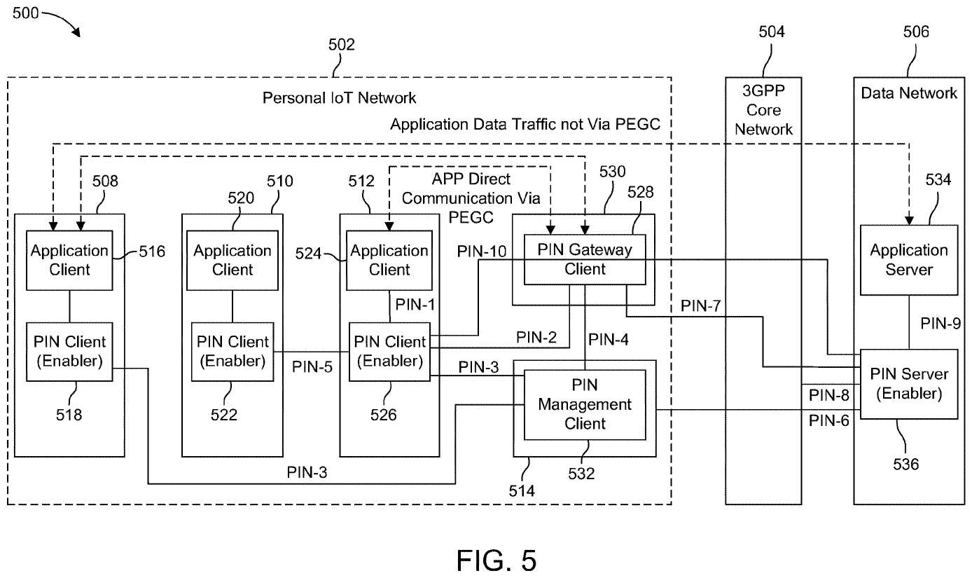

FIG. 5 is a block diagram of an example PINAPP architecture 500. In the example illustrated in FIG. 5, the PINAPP architecture 500 includes a PIN 502, which includes five PINEs 508, 510, 512, 514 and 530. The example PINAPP architecture 500 further includes a 3GPP Core network 504 and a data network 506. The PIN 502 may use the 3GPP Core Network 504 to communicate with an application server (AS) 534 on the data network 504 in some embodiments.

Each of the PINEs 508, 510 and 512 includes an application client 516, 520, 524, respectively, and a PIN client 518, 522, 526, respectively. The PINE 514 may be a PEGC that includes a PIN gateway client 528. The PINE 514 may be a PEMC that includes a PIN management client 532. The application clients 516, 520, 524 of the PINEs 508, 510, 512 may communicate with the AS 534 of the data network 506 either directly via 5GS or indirectly via the PEGC 530. Within the PIN 502, the application clients 516, 520, 524 may communicate with other application clients in the same PIN 502 directly or via the PEGC 530. The application clients 516, 520, 524 may also communicate with other application clients in another PIN via the PEGC 530. The data network 506 may also include a PIN server 536, which may provide configuration information to WTRUs, authorize PIN creation requests, and arrange PEGC information about access control to the PIN 502.

As mentioned above, a PIN may include different PINEs (e.g., sensors, AR/VR, smart TV, etc.). These PINEs may have different requirements (e.g., monitoring, maintenance, tracking) and may require access to different 5G core networks services. As a result, PINEs may need to use different PIN GWs (PEGCs) to communicate with the respective/supporting core networks to access their required services.

A PINE may attach to a PEGC to access 5G core network services. Due to mobility, a PINE can lose connectivity with the PEGC. A PINE can lose connectivity with the PEGC for multiple reasons, such as mobility of the PINE (where a mobile PINE moves away from the PEGC and is out of range), mobility of the PEGC (where a mobile PEGC moves away from the PINE and eventually the radio signals between PINE and PEGC degrade leading to disruption in communication), and/or PIN reconfiguration (when PEMC, deciding on its own or being instructed by the PIN server, may remove the PEGC, which is connected to the PINE). For PIN reconfiguration, the PEMC can instruct the PINE to find another PEGC.

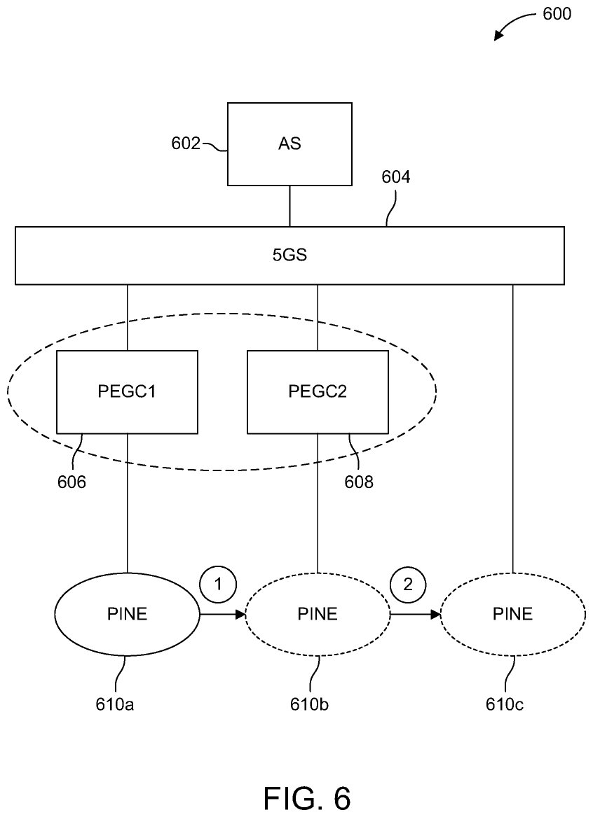

FIG. 6 is a signal diagram showing an example scenario where a PINE 610a detaches from its current PIN gateway PEGC-1 606 and attaches to another PIN gateway PEGC-2 608 (as represented by PINE 610b). Alternatively or additionally, the PINE 610a can move out of the PIN completely and access service through 5GS 504 (as represented by PINE 610c).

The PINE 610 may have a session setup with an AS (not shown) through PEGC1 606 when accessing a service like streaming, monitoring and/or AI/ML. Due to the PINE 606 going out of communication range or PIN reconfiguration, the service with PEGC1 606 may be disrupted. To provide service continuity, the PINE 610 may need to find another PEGC (e.g., PEGC2 608) to connect to the AS 602 via the 5GS 604. Then, the ongoing session among the PINE 610, PEGC1 606, and AS may be resumed/continued through PEGC2 608.

In order to provide service continuity, some issues need to be considered. For example: how to identify the session context that needs to be resumed with the new PEGC, how to resume the service through the new PEGC with minimal disruption, such as no repetition, waiting etc., and how to configure the PEGC and AS for resuming service with minimum disruption. Additionally, when PEGC's are unavailable for PINE connectivity, by default the PINE may connect to the application server through the 5GS. Accordingly, in order to provide service continuity, it should also be determined how to resume service through the 5GS with minimal disruption when the PINE is out of PIN coverage or the PEMC is unavailable. Additionally, to be able to resume the service, there should be capability to identify and mark an application session that needs service continuity (SC). Additionally, how the identified application session context can be maintained and resumed to provide service continuity as the PINE changes PEGCs should be addressed.

More specifically, due to mobility or PIN reconfiguration, a PINE can lose connectivity to the AS. To maintain service continuity, embodiments described herein may provide for a PINE subscribing for service continuity with a PIN Server or PEMC. The PEMC may authorize the request with a PCS/PIN Server. Once the PEMC is authorized, it can initiate action to maintain service continuity. Additionally or alternatively, when a PINE loses connectivity, it may inform the PEMC about the last packet received successfully, and buffering may start either at the AS or in the PEGC. Additionally or alternatively, after the PINE regains connectivity with the new PEGC, the session may be resumed by the AS based on the new destination information and buffer information. For scenarios involving PIN reconfiguration, the PEMC may configure the PINE and PEGC and then reconfigure the PIN. The PEMC may inform the PIN Server and AS to start buffering. When the PINE reconnects to another PEGC, the session may be resumed. Context information may be used, in one, more or all embodiments described herein, to keep track of PINE, PEGC information, policy information and application context, such as last packet received, application state, etc. In some embodiments, as described in more detail below, the policy information may be or include a context token.

A context token may be a data structure, which may include PINE session related information, which may be exchanged in the PIN environment by the PIN Server (PCS), PIN manager (PEMC), PIN gateway (PEGC) and application server (AS) to set-up/resume a session. The context token may be created by the PCS for global reference for a service session and optionally maintained and modified by the PEMC locally for an individual PIN. If authorized by the PCS, the context token can be updated dynamically by the PEMC, PEGC and PINE. Attributes of an example context token are given in TABLE 1 below.

TABLE 1
ContextToken DATA TYPE

| Attribute name | Data type | Cardinality | | Description |
|---|---|---|---|---|
| tokenId | String | 1 | Required | Identifier for this token |
| pinId | String | 1 | Required | Identifier of the PIN. This |
| | | | | attribute shall be unique |
| | | | | across 5GS |
| >pinDescription | Long text | 1 | Required | Human-readable |
| | strings | | | description of the PIN, for |
| | | | | example, the company |
| | | | | name, location or the type |
| | | | | of service. |
| pineList | List of PINE | 1 . . . N | Required | List of PINEs involved in |
| | | | | service continuity feature |
| >pineId | String | 1 | Required | Identifier of the PIN |
| | | | | element in the PIN. This |
| | | | | attribute shall be unique. |
| >type | String | 1 | Required | Involved PINEs can be of |
| | | | | type: PINE, PEMC, |
| | | | | PEGC-S, PEGC-T |
| >gpsi | String | 1 | Optional | Generic Public |
| | | | | Subscription Identifier for |
| | | | | the PIN element. This |
| | | | | attribute is unique and |
| | | | | assigned by the service |
| | | | | provider |
| >ipAddress | String | 1 | Optional | IP v4 address assigned to |
| | | | | network elements |
| >msisdn | String | 1 | Optional | Identifier for a subscription |
| | | | | in a global system for |
| | | | | mobile communication. |
| | | | | This attribute shall be |
| | | | | unique and assigned by |
| | | | | network operator |
| >pinePolicy | Long text | 1 | Required | Collection of rules to |
| | strings | | | govern the behavior of the |
| | | | | PIN element in the PIN. |
| | | | | Policy related to service |
| | | | | continuity of the PINE |
| | | | | such as: |
| | | | | 1. SC will be allowed |
| | | | | or not |
| | | | | 2. allowed QoS |
| | | | | during SC |
| | | | | 3. PINE location to |
| | | | | avail SC |
| | | | | 4. Time restrictions to |
| | | | | avail SC |
| | | | | 5. Network resources |
| | | | | reserved for SC |
| applicationServerId | String | 1 | Required | Identifier of the application |
| | | | | server. This attribute shall |
| | | | | be unique |
| >serviceId | String | 1 | Required | Identifier of the service in |
| | | | | the application server |
| | | | | being availed by the PIN |
| | | | | element. This attribute |
| | | | | shall be unique |
| sessionId | String | 1 | Optional | |
| applicationContext | Struct | | | |
| >pkt_marker | String | | | Markers used for |
| | | | | identifying application data |
| | | | | packets, especially for the |
| | | | | purpose of starting and |
| | | | | releasing buffers |
| >app_context | String | | | Set of data that identifies |
| | | | | application context: |
| | | | | Logical state |
| | | | | Tables and data |
| | | | | Counter values |
| | | | | Timer values |

With reference to TABLE 1, the Token ID may be a unique identifier of the context token exchanged between the elements in the PIN and may be a string datatype. Application clients can query for a token using the Token ID. A PIN identifier may be required to identify the PIN network in a 5G system. The PIN ID may be a string datatype. The PIN ID may have sub-attributes, such as PIN description, which may elaborate information like PIN location, PIN manager (service provider or any 3^{rd} party), type of service the PIN network provides (e.g., health monitoring, streaming, security surveillance etc.). This attribute may store a large amount of information and require rich text formatting and, hence, may be a long text string datatype.

A PINE list may list the PINEs involved in service continuity and may include sub attributes, such as PINE ID. A PINE ID may be a unique identifier of the PIN element in the PIN network. The identifier may help to identify the type of PIN element such as PINE, PEMC, PEGC-S, or PEGC-T. The identifier can be one or more of GPSI, IP address, or MSISDN. Further, PINE policy, which may be of datatype long text string, may list the rules related to service continuity for the PINE. Policies may include but are not limited to: whether or not the SC will be allowed for a particular PINE, the QoS of the SC for the PINE, PINE location to avail the service continuity feature, time restriction or available time slots to be able to avail SC, and/or network resources reserved to achieve SC.

An Application Server ID may be a unique identifier of the AS. When a context token is parsed, this attribute may be required to identify the platform from where the PINE consumes service. The service ID, a sub type for Application Server ID, may be a string and may identify the service hosted in the AS that is being consumed by the PINE. Service could be anything, including, for example, AI/ML, streaming, and/or monitoring. The session identifier (session ID) may either be included in the context token or explicitly sent in the message exchanges in the PIN environment. The session ID may be a string and may identify the session setup between the PINE and AS.

An application context may include a string datatype pkt_marker, used for identifying application data packets, especially for the purpose of starting and releasing buffers. The application context may store information about the logical state of the application, state variables, tables, data, counter values and timer values.

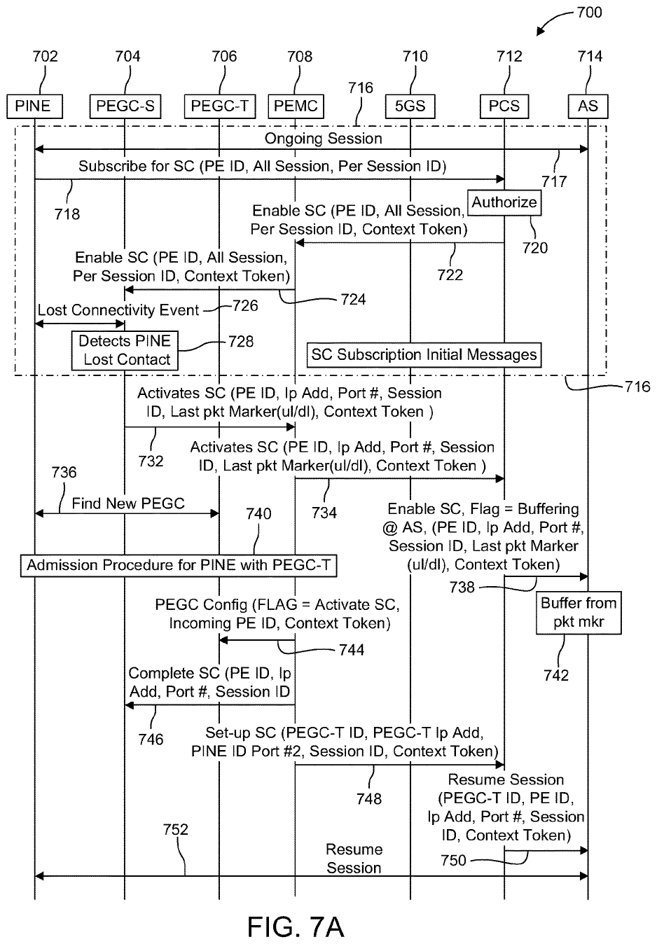

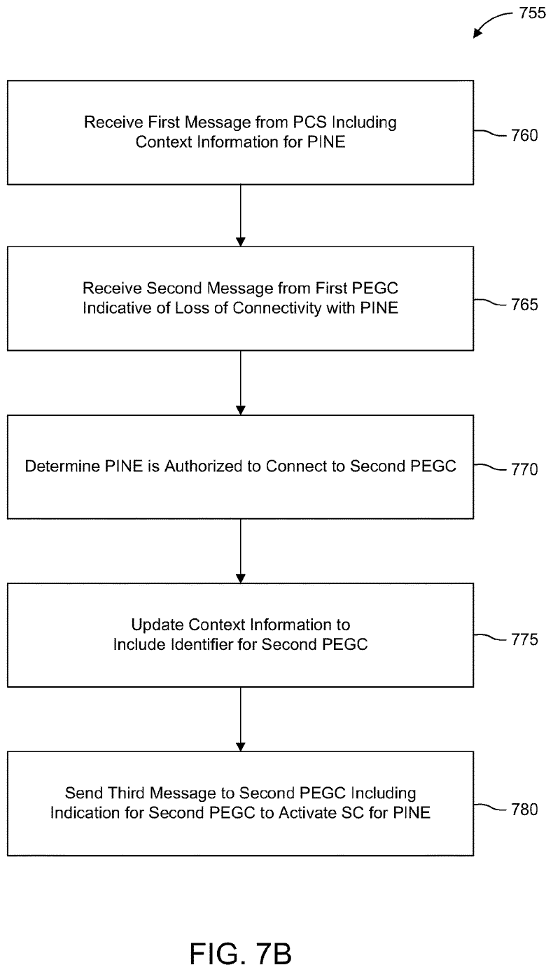

FIG. 7A is a signal diagram 700 showing an example of effecting service continuity. A PINE 702 may have a session setup with an AS 714 for consuming services, such as streaming, monitoring, and/or AI/ML, via a 5GS 710. The AS 714 may provide a compute platform for hosting applications that the PINE 702 consumes. In the example illustrated in FIG. 7, while the PINE 702 may be involved in an ongoing service session (717) with the AS 714, it may subscribe for service continuity (SC) with the PIN configuration server (PCS) 712 in case the PINE 702 is unable to connect to the PEGC. In the subscription request (718), the PINE 702 may send one or more of its PINE ID (PE ID) (may be a PINE unique identifier that can be any of, for example, GPSI, IP address, MSISDN, etc.), an indication that all sessions need SC (can be as simple as a flag indicating all sessions need SC), and/or the individual session's ID (can be a list of specific session IDs for which the SC is requested). For all sessions, optionally, the subscription request (718) can include information that all the sessions running at the PINE can be included. This subscription request (718) from PINE 702 to the PCS 712 can be sent over the user plane using an application-level mechanism such as a REST API. Alternatively, the PINE 702 can request SC from PEMC 708 with the same set of information. The PEMC 708 can get the request authorized by the PCS 712.

On receiving the request from the PINE 702 or the PEMC 708, the PCS 712 may authorize (720) the PINE 702 for SC and create context information, such as a context token, as described in detail above. Referring to TABLE 1 above, the context information, such as a context token, may include information such as PINE ID of the PINE 702, PINE policy, AS ID from where the PINE 702 is consuming service (e.g., the AS 714 in FIG. 7A), and an ID of the service accessed by the PINE 702 and hosted in the AS 714. The PCS 712 may send an Enable SC message (722) to a PINE with management capability (PEMC) 708 and may provide the context information to allow the PEMC 708 to keep track of the PINEs, including the PINE 702, and the associated sessions that need SC.

The PEMC 708 may parse the context token to determine the authorized PINEs for SC treatment. It can also determine the PEGC associated with the PINE 702, such as the PEGC-S 704. The PEMC 708 may inform the PEGC-S 704 about the PINE 702 and the session, which may be eligible for SC, by sending an enable SC message (724). In the same message, the PEMC 708 can also send the context token to the PEGC-S 704. The PEGC-S 704 may parse the context token to identify the PINE 702 and the session that needs SC.

Events, such as PINE mobility, can cause the PINE 702 to lose connectivity with the PEGC-S 704. It may be assumed that when the connectivity is lost (726), the PEGC client can get an event notification from lower layers, such as a Connectivity Lost event (e.g., Wi-Fi, BT L2 event), which can include the Device ID or the PINE ID. Based on the PINE ID, the PEGC 704 may retrieve the context token, identify the Session ID or otherwise detect that the PINE 702 lost contact with the PEGC-S 704 (728). The PEGC 704 can also store the last packet sent successfully for the session when the connectivity was lost. The signaling including 717, 718, 722, and 724 may collectively be considered to be SC subscription initial messages 716 and may be used to set up a service continuity service for the PINE 702 in the event it loses connection with the PEGC-S 704.

After receiving the connectivity lost event notification, the PEGC client may send an activate SC message (732) to the PEMC 708 including the PE-ID of the PINE it lost, along with its own IP address and the Context Token. The PEGC-S 704 may also send a packet marker, which may be set to last packet sent successfully, to the PEMC 708. The activate SC message (732) along with the PINE, packet marker and context token related information may be forwarded to PCS 712 (734).

The PCS 712 may inform the AS 714 about the SC activation for the PINE 702 by sending an enable SC message (738). The message (738) may contain the context token, which can include the PINE ID, Session ID, IP address of the PEGC-S 704, the Port # of PEGC-S 704, and/or the packet marker. The AS 714 may identify the session based on the PINE ID, Session ID and/or PEGC address. It may start buffering the application data packets from the packet marker, scheduled to be sent to the PINE 702. The flag Buffering @ AS may be indicated in this message. This flag may be set to TRUE if buffering is enabled at the AS 714. Alternatively, it may be set to FALSE if buffering is not enabled at the AS 714. In this scenario, buffering is enabled at the AS 714, and the flag Buffering @ AS=TRUE.

The PINE 702 may find a new PEGC (PEGC-T) 706 (736) and may connect to it. The PEMC 708 may be aware of the PINE 702 and that it has connected to the PEGC-T 706. Alternatively, the PEGC-T 706 can inform the PEMC 708 about the new PINE 702. The PINE 702, PEGC-S 704, PEGC-T 706 and PEMC 708 may perform an admission procedure with the PINE 702 with the PEGC-T 706 (740). For example, the PEGC-T 706 may set up a session with the PINE 702 based on the PINE ID and policy information.

In a scenario where the PEGC-S 704 and PEGC-T 706 are not managed by the same PEMC, an inter-PEMC procedure to exchange the SC Context token may be used. For example, the PEGC-T 706 may inform the new PEMC that it needs SC. The new PEMC may request SC information for the PINE from a PCS by sending the PINE ID. The PCS, based on the PINE ID, may send the old PEMC information. The new PEMC may contact the old PEMC to obtain the Context Token. The new PEMC may parse the context token to identify the PINE, session ID, AS ID, policy, etc. It can update the context token with the new information such as PEGC-T information.

The PEMC 708 may configure the PEGC-T 706 for service continuity with the incoming PINE 702. The PEMC 708 may send a PEGC configuration message (744) that may include the PINE ID and Context Token and have a FLAG set to activate SC. The PEGC-T 706 may set up a port # for receiving the incoming packets from the AS 714, which may be configured to receive packets from the AS 714 using the AS ID and/or AS IP address.

The PEMC 708 may send the PEGC-S 704 a complete SC message (746), which may inform the PEGC-S 704 that is can now remove resources and delete the PINE context (e.g., the PE ID, session ID and port number corresponding to the PINE 702). The PEMC 708 may request the PCS 714 to set up the new session (748) with the PINE 702 through the PEGC-T 706, providing the PEGC-T ID, the PEGC-T IP address for layer 3 routing of the application data packets, PINE ID, Port # of the session to be with the AS 714, Session ID, and Context token.

The PCS 712 may send a resume session command (750) to the AS 714 to resume the service session with the PINE 702 through the PEGC-T 706 by sending all the necessary PEGC-T related information. This information may include one or more of: the PEGC-T ID (the PEGC-T identifier), PINE ID (PE ID) and IP address of the PINE 702 with which the AS 714 will resume the session, the port # of the port reserved for the session establishment between the AS 714 and the PEGC-T 706, and the context token including the PIN ID and the policy of the PINE 702. The session ID may be the identifier of the session the AS 714 will setup with the PINE 702 through the PEGC-T 706 and the corresponding port number where the session terminates. After receiving the configuration information, the AS 714 may configure the session by, for example: changing the IP address from the PEGC-S 704 to the PEGC-T 706, changing to the new port # provided by the PEGC-T 706, including the PINE address in the packet header, using the session ID to identify the buffer, and using the packet marker to release the buffer and resume service.

FIG. 7B is a flow diagram of an example method 755 of effecting service continuity. In the example illustrated in FIG. 7B, the method may be implemented in a PEMC, which, in some embodiments, may be a WTRU.

The PEMC may receive a first message from the PCS (760). The first message may include context information for at least one PINE. The context information may contain at least an identifier for the at least one PINE element that is being authorized for SC, an identifier for at least one session set up for the at least one PINE with an AS, and an identifier for a first PEGC that is providing 3GPP network services to the at least one PINE for the at least one session. In some embodiments, the context information may be or include a context token. The context information may, in some embodiments, further include at least one of an identifier of the PIN, a list of PINEs, including the PINE, subscribing to SC services, a type of each PINE in the list, a PINE policy that governs behavior of the plurality of PINEs in the PIN, or identifiers of one or more services in the AS being used by the plurality of PINEs. In some embodiments, the first message may be an enable SC message.

The PINE may be a non-3GPP device configured to communicate with other PINEs in the PIN using non-3GPP communication. The at least one session with the AS may be for at least one of streaming, monitoring, artificial intelligence (AI) or machine learning (ML). The 3GPP network services may be 5G network services in some embodiments.

The PEMC may receive a second message from the first PEGC, which may be indicative of loss of connectivity with the at least one PINE (765). The second message may also include the identifier for the at least one PINE and the context information. In some embodiments, the second message may also contain a marker for a last packet successfully sent for the at least one session. In some embodiments, the PEMC may forward the second message to the PCS. In some embodiments, the second message may be an SC activation message.

The PEMC may determine that the at least one PINE is authorized to connect to a second PEGC (770). In some embodiments, the PEMC may determine that the at least one PINE has connected to a second PEGC based on one of receiving a message from the second PEGC that contains information about the PINE or detecting that the PINE has connected to the second PEGC.

The PEMC may update the context information to include an identifier for the second PEGC (775). The PEMC may send a third message to the second PEGC including an indication for the second PEGC to activate SC for the at least one PINE (780). The third message may also include the updated information and the identifier for the at least one PINE. In some embodiments, the third message may be a PEGC configuration message.

In some embodiments, the PEMC may send a fourth message to the first PEGC after sending the third message to the second PEGC. The fourth message may contain an indication that the first PEGC can remove resources and delete information related to the context information. In some embodiments, the fourth message may be an SC complete message. In some embodiments, the PEMC may send a fifth message to the PCS after sending the third message to the second PEGC. The fifth message may contain a request for the PCS to set up a new session for the PINE with the AS and the updated context information. In some embodiments, the fifth message may be an SC setup message.

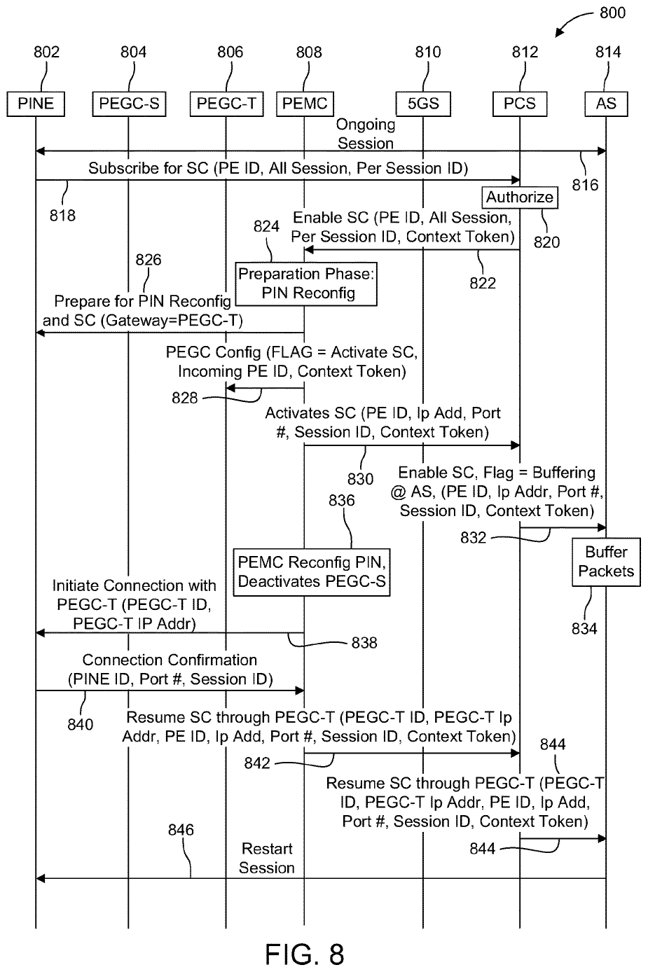

FIG. 8 is a signal diagram 800 of another example of effecting service continuity. In example illustrated in FIG. 8, the PINE may be considered to be static and the PINE does not experience a change in PEGC due to a mobility event. However, the PINE may experience a PEGC change due to other events, such as PIN reconfiguration, PEGC failure and PINE or PEGC mobility (out of communication range).

Similar to FIG. 7A, in the example illustrated in FIG. 8, a PINE 802 may have a session setup with an AS 814 for consuming services, such as streaming, monitoring, and/or AI/ML, via a 5GS 810. The AS 814 may provide a compute platform for hosting applications that the PINE 802 consumes. In the example illustrated in FIG. 8, while the PINE 802 may be involved in an ongoing service session (816) with the AS 814, it may subscribe for service continuity (SC) with the PIN configuration server (PCS) 812 in case the PINE 802 is unable to connect to the PEGC. In the subscription request (818), the PINE 802 may send one or more of its PINE ID (PE ID) (may be a PINE unique identifier that can be any of, for example, GPSI, IP address, MSISDN, etc.), an indication that all sessions need SC (can be as simple as a flag indicating all sessions need SC), and/or the individual session's ID (can be a list of specific session IDs for which the SC is requested). For all sessions, optionally, the subscription request (818) can include information that all the sessions running at the PINE can be included. This subscription request (818) from PINE 702 to the PCS 812 can be sent over the user plane using an application-level mechanism such as a REST API. Alternatively, the PINE 802 can request SC from PEMC 808 with the same set of information. The PEMC 808 can get the request authorized by the PCS 812.

On receiving the request from the PINE 802 or the PEMC 808, the PCS 812 may authorize (820) the PINE 802 for SC and create context information, such as a context token, as described in detail above. Referring to TABLE 1 above, the context information, such as a context token, may include information such as PINE ID of the PINE 802, PINE policy, AS ID from where the PINE 802 is consuming service (e.g., the AS 814 in FIG. 8), and an ID of the service accessed by the PINE 802 and hosted in the AS 814. The PCS 812 may send an enable SC message (822) to a PINE with management capability (PEMC) 808 and may provide the context information to allow the PEMC 808 to keep track of the PINEs, including the PINE 802, and the associated sessions that need SC.

Due to policy related reasons, the PEMC 808 may opt for PIN reconfiguration. Prior to commencing the reconfiguration procedure, the PEMC 808 may select a suitable PEGC for the PINE 802 after parsing the received PINE context token information. The PEMC may initiate a preparation phase (824) by sending a prepare for PIN reconfiguration and SC message (826) to inform the PINE 802 that it may lose connectivity with the PEGC-S 804 and may include information about a suitable PEGC-T 806 with which it can connect for service continuity.

The PEMC 808 may configure the PEGC-T 806 for service continuity with the PINE information, which may connect to it after the reconfiguration. The PEMC may send a PEGC configuration message (828), which may include the PINE ID and Context Token and may optionally set a FLAG to Activate SC. The PEGC-T 806 may use the PINE ID and Policy information to discover and/or authorize the PINE 802. The PEGC-T 806 may parse the context token to prepare for receiving packets from the AS 814 by using the AS ID and AS IP address. The PEGC-T 806 may set up a port # for receiving the incoming packets from the AS 814 with the AS ID and AS IP address. Optionally, a flag Activate SC can be indicated in the message. The flag Activate SC, if set to TRUE, may enable the PEGC-T 806 to start discovery of the PINE 802 based on the PINE ID and may set up a session with the PINE 802 based on the PINE ID and Policy information. The flag can also be set to HOLD or FALSE. In those cases, the PEGC-T 806 will not start discovery and session setup with the PINE 802.

The PEMC 808 may send an activate SC message to the PCS 812 (830). The message may include the PINE ID of the PINE for which SC activation is requested, along with the PINE's IP address, session ID and port # of the PINE reserved for incoming connection from the AS 814. The PEMC 808, in this stage, may update the context token to include the new PEGC-T related information.

The PCS may parse the context token to determine the PINE ID and PEGC-T information. Based on this information, it may retrieve the PEGC-T policy information and update the context token. It may also retrieve the application server ID, AS IP address, and Service ID from the context token to determine the appropriate AS for resuming the service continuity. The PCS may inform the AS 814 (832) about the SC treatment for PINE by sending an enable SC message. The message can include the PINE ID, Session ID, and Context Token, which can have PEGC-S, PEGC-T, Application context and policy related information.

The flag Buffering @ AS may be indicated in the enable SC message (832) from the PCS 812. This flag may be set to TRUE if buffering is enabled at the AS 814. Alternatively, it may be set to FALSE if buffering is not enabled at the AS 814. In this scenario, the buffering may be enabled at the AS 814, and, hence the flag Buffering @ AS=TRUE. The AS 814 may identify the session based on the PINE ID and/or Session ID. The AS 814 may parse the context token to determine the application context, PEGC information and policy. Based on these, the AS 814 may start buffering the data packets from the last sent application packet to the PEGC-S 804 (834). The AS 814 can update the context token with the last sent application packet to PEGC-S information.

The PEMC 808, after reconfiguring the PIN (836), may deactivate the PEGC-S 804 such that all the network resources reserved for the PEGC-S 804 in the PIN may be released, and all the service sessions through the PEGC-S 804 may be discontinued. The PEGC-S's endpoint information and ID may be removed from the PEMC's repository.

The PEGC-T 806 may already be configured with SC for the incoming PINE 802. Hence, at this stage, the PEMC 808 may initiate the connection between the PINE 802 and the PEGC-T 806. Setting up PINE connectivity with the new gateway client may allow communication between the PINE 802 and the AS 814 through the PEGC-T 806. The PEMC 808 may send an Initiate Connection with PEGC-T message (838) to the PINE 802, which may include the PEGC-T ID and PEGC-T IP address.

The PINE may send a connection confirmation message (840) to the PEMC 808 to update the PEMC 808 about the Session ID and the port number the PINE 802 has reserved for incoming connection from the AS 814. When the PEMC 808 receives the connectivity confirmation message from the PINE 802, the PEMC 808 may inform PCS 812 that the PINE 802 is configured and ready to resume service continuity through the PEGC-T 806 by sending a resume session message (842). The message (842) may include the PEGC-T ID and the context token. From TABLE 1, the context token can include one or more of a PEGC-T IP address, PEGC-T port #, PINE ID and PINE IP address, Session type and Session ID, AS ID, Service ID, PINE policy and/or updated application context if any. The PCS 812 may parse the context token to verify the AS ID and/or AS IP address based on the PINE ID and policy information.

The PCS 812 may send a resume SC command (844) to the AS 814 to resume the service session with the PINE 802 through the PEGC-T 806 by sending PEGC-T related information. Such information may include, for example, a PEGC-T ID and IP address (this piece of information may help the AS 814 to identify the PEGC-T 806 and initiate routing for packet delivery), PINE ID and IP address (may enable identifying the PINE with which the session will resume), port # of the port reserved for the session establishment between the AS 814 and the PEGC-T 806, session ID and context token. The session ID may be the identifier of the session the AS 814 will setup with the PINE 802 through the PEGC-T 806 and the corresponding port number where the session terminates. The context token may include the PIN ID and the policy of the PINE 802.

After receiving the configuration information, the AS 814 may configure the session (846). In doing so, the AS 814 may change the IP address from the PEGC-S 814 to the PEGC-T 806, change to the new port # provided by the PEGC-T 806, include the PINE address in the packet header, use the session ID to identify the buffer, and release the buffer since the last sent data packet for the given session ID.

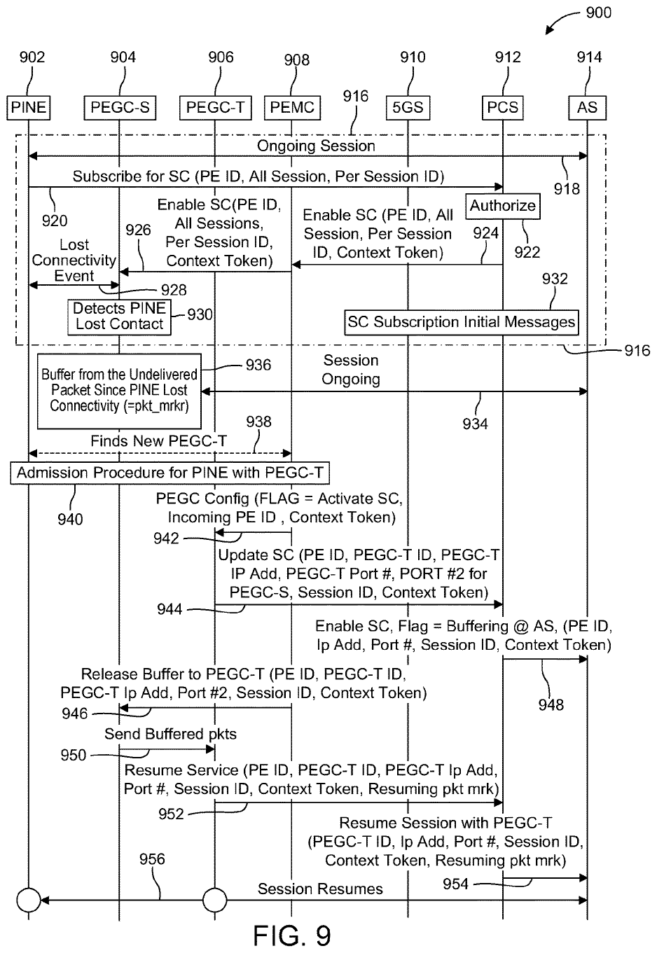

FIG. 9 is a signal diagram 900 of another example of effectuating service continuity. The initial message exchanges for service continuity may be similar to FIG. 7A and the related description, and this phase may be termed as SC subscription initial messages (916). In the example illustrated in FIG. 9, A PINE 902 may have a session setup with an AS 914 for consuming services, such as streaming, monitoring, and/or AI/ML, via a 5GS 910. The AS 914 may provide a compute platform for hosting applications that the PINE 902 consumes. In the example illustrated in FIG. 9, while the PINE 902 may be involved in an ongoing service session (918) with the AS 914, it may subscribe for service continuity (SC) with the PIN configuration server (PCS) 912 in case the PINE 902 is unable to connect to the PEGC. In the subscription request (920), the PINE 902 may send one or more of its PINE ID (PE ID) (may be a PINE unique identifier that can be any of, for example, GPSI, IP address, MSISDN, etc.), an indication that all sessions need SC (can be as simple as a flag indicating all sessions need SC), and/or the individual session's ID (can be a list of specific session IDs for which the SC is requested). For all sessions, optionally, the subscription request (920) can include information that all the sessions running at the PINE can be included. This subscription request (920) from PINE 902 to the PCS 912 can be sent over the user plane using an application-level mechanism such as a REST API. Alternatively, the PINE 902 can request SC from PEMC 908 with the same set of information. The PEMC 908 can get the request authorized by the PCS 912.

On receiving the request from the PINE 902 or the PEMC 908, the PCS 912 may authorize (922) the PINE 902 for SC and create context information, such as a context token, as described in detail above. Referring to TABLE 1 above, the context information, such as a context token, may include information such as PINE ID of the PINE 902, PINE policy, AS ID from where the PINE 902 is consuming service (e.g., the AS 914 in FIG. 9), and an ID of the service accessed by the PINE 902 and hosted in the AS 914. The PCS 912 may send an enable SC message (924) to a PINE with management capability (PEMC) 908 and may provide the context information to allow the PEMC 908 to keep track of the PINEs, including the PINE 902, and the associated sessions that need SC.

The PEMC 908 may parse the context token to determine the authorized PINEs for SC treatment. It can also determine the PEGC associated with the PINE 902, such as the PEGC-S 904. The PEMC 908 may inform the PEGC-S 904 about the PINE 902 and the session, which may be eligible for SC, by sending an enable SC message (926). In the same message, the PEMC 908 can also send the context token to the PEGC-S 904. The PEGC-S 904 may parse the context token to identify the PINE 902 and the session that needs SC.

Events, such as PINE mobility, can cause the PINE 902 to lose connectivity with the PEGC-S 904. It may be assumed that when the connectivity is lost (928), the PEGC client can get an event notification from lower layers, such as a Connectivity Lost event (e.g., Wi-Fi, BT L2 event), which can include the Device ID or the PINE ID. Based on the PINE ID, the PEGC 904 may retrieve the context token, identify the Session ID or otherwise detect that the PINE 902 lost contact with the PEGC-S 904 (930). The PEGC 904 can also store the last packet sent successfully for the session when the connectivity was lost.

Events, such as PINE mobility, can cause the PINE 902 to lose connectivity with the PEGC-S 904 and possibility cause service discontinuity. Even though the PINE 902 may lose connectivity with the AS 914, the PEGC-S 904 may still maintain a live service session with the AS 914 (934). This event may trigger buffering of the application data packets (936) from the AS 914 sent to the PINE 902 at the PEGC-S 904. The packet buffering (936) at the PEGC-S 904 may be initiated for the undelivered packets, marked with packet marker and may be scheduled to be sent to the PINE 902 once it regains connectivity.

The PINE 902 may find a new PEGC client (PEGC-T 906) and connect to the PEGC-T 906 (938). The PEMC 908 may be aware that the PINE 902 has connected to the PEGC-T 906. Alternatively, the PEGC-T 906 can also inform the PEMC 908 about the new PINE connectivity. In a scenario where the PEGC-S 904 and the PEGC-T 906 are not managed by the same PEMC, an inter-PEMC procedure to exchange the SC context token may be required. The inter-PEMC procedure may include the PEGC-T 906 informing the new PEMC that it needs SC. The new PEMC may request from the PIN Server SC information for the PINE 902 by sending the PINE ID. The PIN server, based on PINE ID, may send the old PEMC information. The new PEMC may contact the old PEMC to obtain the context token. The context token may list information for one or more sessions that needs service continuity. The new PEMC may parse the context token to identify the PINE, Session ID, AS ID, Policy etc. It can update the context token with the new information such as PEGC-T information. This procedure may be referred to as an admission procedure for the PINE 902 with the PEGC-T 906 (940).

The PEMC 908 may configure the PEGC-T 906 for service continuity with the incoming PINE 902. The PEMC 908 may send a PEGC configuration message (942), which may include the PINE ID and/or context token, and may set a FLAG to activate SC. The PEGC-T 906 may set up a session with the PINE 902 based on the PINE ID and/or policy information. The PEGC-T 906 may set up a port # for receiving the incoming packets from the AS 914, configure to receive packets from the AS 914 using the AS ID and the AS IP address. Optionally, a flag activate SC can be indicated in the message. The flag activate SC, if set to TRUE, may enable the PEGC-T 906 to set up a session with the PINE 902 based on the PINE ID and policy information. The flag can also be set to HOLD or FALSE; in those cases, the PEGC-T 906 may not start setting up the session with the PINE 902.

The PEMC 908 may send an update SC message (944) to the PCS 912. This message may provide the PCS 912 with the information that SC for the PINE 902 will be initiated through the PEGC-T 906. The update SC message may include the PINE ID of the PINE 902 that needs service continuity, the PEGC-T ID, port # and IP address (which can be used by the AS 914 to resume service through the PEGC-T 906), PEGC-S IP address and port #(allows the PCS 912 to notify the AS 914 that the service session established with the PEGC-S's port #2 should be discontinued and resume the service session for the PINE 902 with PEGC-T's port #). The context token may be updated by the PEMC 908 with the new PEGC-T information.

The PCS 912 may inform the AS 914 about the SC treatment for the PINE 902 by sending an enable SC message (948). The message may contain the context token, which can include the PINE ID, session ID, IP address of PEGC-S 904, and/or Port # of the PEGC-S 904. The AS 914 may identify the session based on the PINE ID, session ID and PEGC address. The flag buffering @ AS may be indicated in this message. This flag may be set to TRUE if buffering is enabled at the AS 914. Alternatively, it may be set to FALSE if buffering is not enabled at the AS 914. In this scenario, buffering may be enabled at the PEGC-S 904. Hence, the flag buffering @ AS=FALSE.

The PEMC may send a release buffer command to the PEGC-S 904 (946). The PEMC 908, in this message, may send the PEGC-T's information to the PEGC-S 904 to enable buffer release to the PEGC-T 906. The list of information in the release buffer message may include: the PE ID of the PINE 902 (for which buffering was enabled in the PEGC-S 904), that the PEGC-T ID and IP address information are required to release the buffer to PEGC-T 906, that the session identifier and Port #2 are required to identify the buffer corresponding to a particular service session that is terminated at the Port #2, and the context token received by the PCS 912 from the PEMC 908 with updated PEGC-T related information. In case the PEGC-S 904 and the PEGC-T 906 are being managed by different PEMCs, then it may follow the inter-PEMC context token exchange procedure described above with respect to FIG. 7A.

At this stage, the PEGC-S 904 may establish a session to transfer the packets in the buffer to the PEGC-T 906 (950). Once the buffer transfer is completed, the session may be deleted, resources pertaining to the session may be released, and the PINE 902 may receive the buffered data through the PEGC-T 906.

When sending the buffered data is complete, the PEGC-T 906 may send a resume service message to the PCS 912 (952). This message may include information such as the PINE ID, PEGC-T ID and IP address, port #, and session ID. The context token may be parsed to retrieve the application server ID, AS IP address, and service ID to determine the appropriate AS for resuming the service continuity.

In the resume service message (952), the PEGC-T 906 may explicitly send the packet marker information to inform the PCS 912 that the session is scheduled to resume from the given marked packet number. The PCS 912 may send a resume SC command to the AS 914 (954) to resume the service session with the PINE 902 through the PEGC-T 906 by sending the PEGC-T related information. This information may include, for example, the PEGC-T ID and IP address. This piece of information may help the AS to identify the PEGC-T 906 and initiate routing for packet delivery from the marked packets. Such information may also include a PINE ID and IP address, which may enable identifying the PINE 902 with which the session will resume. Such information may also include the port # of the port reserved for the session establishment between the AS 914 and the PEGC-T 906, the session ID and the context token. The session ID may be the identifier of the session the AS 914 will setup with the PINE 902 through the PEGC-T 906 and the corresponding port number where the session terminates. The context token may include the PIN ID and the policy of the PINE 902.

After receiving the configuration information, the AS 914 may configure the session. This may be done, for example, by changing the IP address from the PEGC-S 904 to PEGC-T 906, change to the new port # provided by PEGC-T 906, include the PINE address in the packet header, and use the packet marker information to resume sending application data from the marked packets. The session may thereby be resumed between the AS 914 and the PINE 902 via the PEGC-T 906 (956).

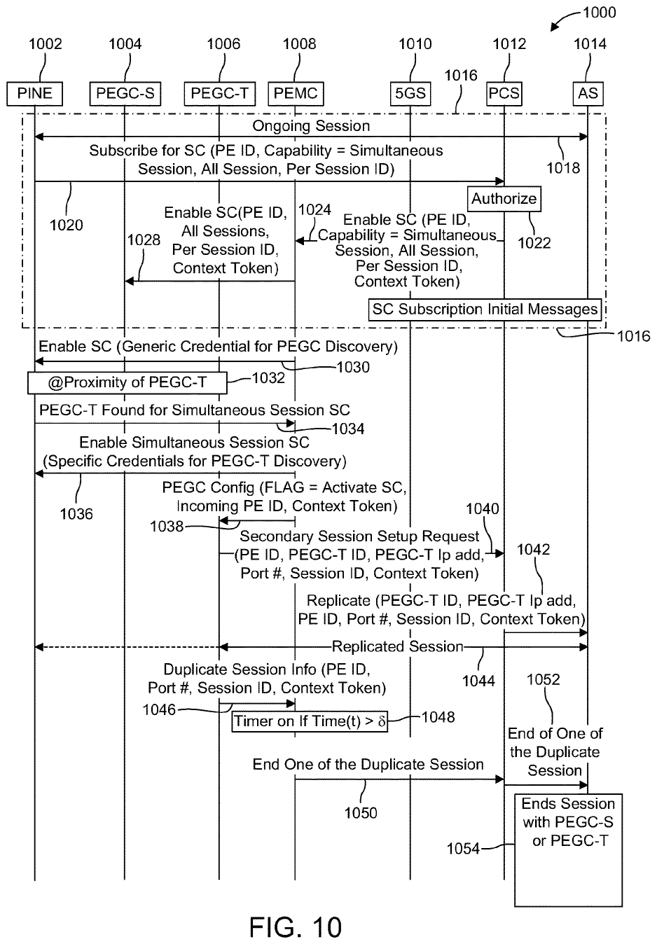

FIG. 10 is a signal diagram 1000 of another example of effectuating SC with simultaneous sessions enabled for the PINE 1002. The initial message exchanges (1016) may be similar to the first few messages in FIG. 9 and the related description.

A PINE 1002 may have a session setup with an AS 1014 for consuming services, such as streaming, monitoring, and/or AI/ML, via a 5GS 1010. The AS 1014 may provide a compute platform for hosting applications that the PINE 1002 consumes. In the example illustrated in FIG. 10, while the PINE 1002 may be involved in an ongoing service session (1018) with the AS 1014, it may subscribe for SC with the PCS 1012 in case the PINE 1002 is unable to connect to the PEGC-S 1004. In the subscription request (1020), the PINE 1002 may send one or more of its PINE ID (PE ID) (may be a PINE unique identifier that can be any of, for example, GPSI, IP address, MSISDN, etc.), an indication that all sessions need SC (can be as simple as a flag indicating all sessions need SC), and/or the individual session's ID (can be a list of specific session IDs for which the SC is requested). For all sessions, optionally, the subscription request (1020) can include information that all the sessions running at the PINE can be included. This subscription request (1020) from PINE 1002 to the PCS 1012 can be sent over the user plane using an application-level mechanism such as a REST API. Alternatively, the PINE 1002 can request SC from PEMC 1008 with the same set of information. The PEMC 1008 can get the request authorized by the PCS 1012. The PINE 1002 may also send information on whether it is capable of supporting simultaneous sessions in the SC subscription message (1020).

On receiving the request from the PINE 1002 or the PEMC 1008, the PCS 1012 may authorize (1022) the PINE 1002 for SC and create context information, such as a context token, as described in detail above. Referring to TABLE 1 above, the context information, such as a context token, may include information such as PINE ID of the PINE 1002, PINE policy, AS ID from where the PINE 1002 is consuming service (e.g., the AS 1014 in FIG. 10), and an ID of the service accessed by the PINE 1002 and hosted in the AS 1014. The PCS 1012 may send an enable SC message (1024) to a PINE with management capability (PEMC) 1008 and may provide the context information to allow the PEMC 1008 to keep track of the PINEs, including the PINE 1002, and the associated sessions that need SC.

The PEMC 1008 may parse the context token to determine the authorized PINEs for SC treatment. It can also determine the PEGC associated with the PINE 1002, such as the PEGC-S 1004. The PEMC 1008 may inform the PEGC-S 1004 about the PINE 1002 and the session, which may be eligible for SC, by sending an enable SC message (1028). In the same message, the PEMC 1008 can also send the context token to the PEGC-S 1004. The PEGC-S 1004 may parse the context token to identify the PINE 1002 and the session that needs SC. Additionally, the PEMC may send an enable SC message (1030) to the PINE 1002 with the credentials such that the PINE 1002 may be able to discover PEGC clients in its proximity.

Events, such as PINE mobility, may result in the possibility of the PINE 1002 losing connectivity with the PEGC-S 1004, leading to service discontinuity. Hence, the PINE 1002 may discover another PEGC client (PEGC-T 1006) in its proximity (1032) with generic credentials. The PINE 1002 may inform the PEMC 1008 about the PEGC-T discovery by sending PEGC-T found for simultaneous session SC message (1034) to the PEMC 1008. The PEMC 1008 may send specific credentials to establish simultaneous connection with the PEGC-T 1006 by sending an enable simultaneous session for SC message (1036) to the PINE 1002. The PINE 1002 can go ahead and setup another connection with the PEGC-T 1006. The PEMC 1008 may be aware of the PINE 1002 setting up a simultaneous connection with the PEGC-S 1004 and PEGC-T 1006.

In a scenario where the PEGC-S 1004 and the PEGC-T 1006 are not managed by the same PEMC, the inter-PEMC procedure to exchange the SC context token may be needed. That procedure may include that the PEGC-T 1006 informs the new PEMC that it needs SC. The new PEMC may request the PCS 1012 about SC information for the PINE 1002 by sending the PINE ID. The PCS 1012, based on the PINE ID, may send the old PEMC information. The new PEMC may contact the old PEMC to obtain the context token. The context token may list information for one or more sessions that need service continuity. The new PEMC may parse the context token to identify the PINE, Session ID, AS ID, Policy, etc. It can update the context token with the new information such as PEGC-T information.

The PEMC 1008 may configure the PEGC-T 1006 for service continuity with the incoming PINE 1002. The PEMC 1008 may send a PEGC configuration message (1038), which may include the PINE ID and the context token. Optionally, a flag activate SC can be indicated in the message. If the flag activate SC is set to TRUE, the PEGC-T (1006) may set up the specific session that needs SC, with the PINE based on PINE ID. The session specific information can be retrieved from the context token, such as SESSION ID, session type, QOS, etc. The flag can also be set to HOLD or FALSE. In those cases, the PEGC-T 1006 will not start session setup with the PINE 1002 and can wait for instruction from PEMC 1008 in the future. The PEGC-T 1006 may set up a port # for receiving the incoming packets from the AS 1014. This may be configured to receive packets from the AS 1014 using AS ID and/or AS IP address.

The PEGC-T 1006 may send a secondary session setup request message (1040) to the PCS 1012 providing the PE ID (PINE ID) for which a secondary session is requested. Additionally, the PEGC-T 1006 may send its own ID and IP address to inform that the secondary session for the given PE ID (PINE ID) needs to be established through the PEGC-T 1006. The PCS 1012 may parse the context token and retrieve: the application Server ID and service ID for identifying the AS 1014 and service the PINE 1002 is consuming, the session ID (the identifier of the session set up between the AS 1014 and the PINE 1002 that requires duplication), and a reserved port number. The reserved port number may be sent to the PCS 1012 for informing that the PEGC-T 1006 will establish the secondary session on the given port number.

The PCS 1012 may send a replicate session message (1042) to the AS 1014 for a secondary service session with the PINE 1002 through the PEGC-T 1006. The secondary session can be used for replication, redundancy, and/or aggregation. In order to replicate a service session, the PCS 1012 may send all the necessary PEGC-T related information to the AS 1014, including: PEGC-T ID (the PEGC-T identifier), the PE ID (PINE ID) and IP address of the PINE 1002 with which the AS 1014 will replicate the session, the port # of the port reserved for the secondary session establishment between the AS 1014 and the PEGC-T 1006, the session ID (the identifier of the session that needs to be replicated and the corresponding port number where the session terminates) and the context token. The context token may include the PIN ID and the policy of the PINE 1002 (e.g., specifying the PINE supports simultaneous sessions for the same service).

When the replicated session setup with the PINE 1002 through the PEGC-T 1006 (1044) is complete, the PEGC-T 1006 may send a duplicate session information message (1046) to the PEMC 1008. The message may include the PINE identifier for which the duplicate session is established and other information, such as session ID, port number and context token.

On receiving the context information of the duplicate session, the PEMC 1008 may trigger a local PIN timer (1048) to observe whether either of the below mentioned events takes place before the PEMC set threshold time expires: one of the replicated sessions gets disconnected due to PINE mobility resulting in losing connectivity with the PEGC-S 1004 or the PEGC-T 1006 or due to PIN reconfiguration one of the PEGC clients (PEGC-S 1004 or PEGC-T 1006) is lost. If either of these two events occurs, the PEMC 1008 may stop and delete the timer. If none of the above two events happens and the duplicate session for the same PINE is maintained, then, in that case, the PEMC 1008 can delete one of the replicated sessions. The decision to delete one of the duplication sessions can be based on PINE policy or based on evaluating the QoS performance of the sessions.

The PEMC 1008 may send an end of duplicate session message to the PCS 1012 (1050). In this message, the PEMC 1008 may inform the PCS 1012 that one of the duplicate sessions selected based on criteria mentioned above may need to be discontinued. The PCS 1012 may forward the end of duplicate session message to the AS 1014 (1052). The PCS 1012 may send in this message the PINE ID, PEGC-S or PEGC-T ID and IP address, and session ID and port number (depending on the session selected for deletion). Based on this information from the PCS 1012, the AS 1014 may configure the session by: deleting one of the sessions based on the session ID sent by the PEMC 1008 (session ID corresponding to the session from either the PEGC-S 1004 or PEGC-T 1006) (1054) and including the PINE address in the packet header.

The PINE 1002 can also initiate the end of duplicate session message. The session selection could be made at a general system level with the help of Quality of Experience (QoE) metrics, such as throughput, reliability, mean opinion score, etc. Alternatively, it is possible that the end of duplicate session message could be sent by the AS 1014. However, the AS 1014 may not have all the local QoS policy related information between the PINE 1002 and the PEGC for making optimal selection on ending either of the two sessions with the PINE 1002.

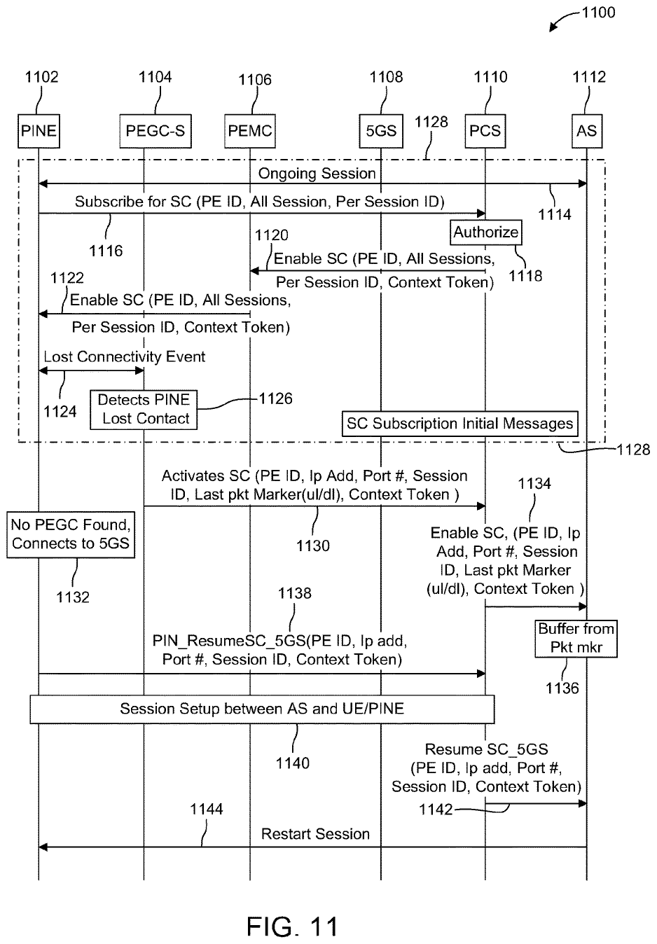

FIG. 11 is a signal diagram of another example of effectuating service continuity through the 5GS 1108. This procedure may allow a WTRU/PINE to connect to the AS 1112 directly through 5GS 1108 without any PEGC client.

The initial message exchanges for SC may be similar to FIG. 9 and the related description, and this phase may be termed as SC subscription initial messages (1128). In the example illustrated in FIG. 11, A PINE 1102 may have a session setup with an AS 1112 for consuming services, such as streaming, monitoring, and/or AI/ML, via a 5GS 1108. The AS 1112 may provide a compute platform for hosting applications that the PINE 1102 consumes. In the example illustrated in FIG. 11, while the PINE 1102 may be involved in an ongoing service session (1114) with the AS 1112, it may subscribe for service continuity (SC) with the PCS 1110 in case the PINE 1102 is unable to connect to the PEGC 1104. In the subscription request (1116), the PINE 1102 may send one or more of its PINE ID (PE ID) (may be a PINE unique identifier that can be any of, for example, GPSI, IP address, MSISDN, etc.), an indication that all sessions need SC (can be as simple as a flag indicating all sessions need SC), and/or the individual session's ID (can be a list of specific session IDs for which the SC is requested). For all sessions, optionally, the subscription request (1116) can include information that all the sessions running at the PINE 1102 can be included. This subscription request (1116) from the PINE 1102 to the PCS 1110 can be sent over the user plane using an application-level mechanism such as a REST API. Alternatively, the PINE 1102 can request SC from PEMC 1106 with the same set of information. The PEMC 1106 can get the request authorized by the PCS 1110.

On receiving the request from the PINE 1102 or the PEMC 1106, the PCS 1110 may authorize (1118) the PINE 1102 for SC and create context information, such as a context token, as described in detail above. Referring to TABLE 1 above, the context information, such as a context token, may include information such as PINE ID of the PINE 902, PINE policy, AS ID from where the PINE 1102 is consuming service (e.g., the AS 1112 in FIG. 11), and an ID of the service accessed by the PINE 902 and hosted in the AS 1112. The PCS 1110 may send an enable SC message (1120) to a PINE with management capability (PEMC) 1106 and may provide the context information to allow the PEMC 1106 to keep track of the PINEs, including the PINE 1102, and the associated sessions that need SC.

The PEMC 1106 may parse the context token to determine the authorized PINEs for SC treatment. It can also determine the PEGC associated with the PINE 1102, such as the PEGC-S 1104. The PEMC 1106 may send an Enable SC command (1122) to the PINE 1102, which may update the PINE 1102 with the SC subscription context token. This context token can be parsed by the PINE 1102 for connection to the AS 1112 through the 5GS 1108.

Events (1124), such as PINE mobility, can cause the PINE 1102 to lose connectivity with the PEGC-S 1104 and the possibility of moving out of the PIN network coverage, leading to service discontinuity. It may be assumed that when the connectivity is lost, the PEGC client can get an event notification from lower layers (1126), such as connectivity lost event (e.g., Wifi, BT L2 event), which can include the Device ID or the PINE ID. Based on the PINE ID, the PEGC 1104 may retrieve the context token and identify the Session ID. The PEGC 1104 may also store the last packet sent successfully for the session when the connectivity was lost.

After receiving the connectivity lost event notification, the PEGC client 1104 may send an activate SC message (1130) to the PCS 1110 including the PE ID of the PINE it lost, along with its own IP address and the Context Token. The PEGC-S 1104 may also send a packet marker, which is set to the last packet sent successfully, to the PCS 1110. Meanwhile, the PINE 1102 may not be unable to connect to any PEGC client (e.g., PINE is not under PIN coverage). The PCS 1110 may inform the AS 1112 by sending an enable SC message (1134) with a list of WTRU-related information. The list may include the PE ID and IP address of the PINE/WTRU, the session identifier and port number, the packet marker, and the context token. The session identifier and port number may be sent such that the AS 1112 can track the corresponding PINE session. The packet marker may be set to last packet received at the PEGC-S 1104 successfully. The context token may include the PINE/WTRU policy and location.

The AS may buffer application data packets from the packet marker (1136) provided by the PCS 1110 until the PINE/WTRU resumes service session connectivity. When the PINE 1102 is out of PIN coverage and connects to the 5GS 1108, it may be denoted as a WTRU (i.e., 3GPP connected device). The PINE may send a message PIN_ResumeSC_5GS (1138) to the PCS 1110 to inform that it wants to resume connectivity with the AS 1112 through the 5G core. The list of information provided along with the message may include the PINE ID and IP address for identification and data plane routing to the PINE, port # and session ID reserved for setting up service session with the AS 1112, and the context token, which may primarily include the PINE/WTRU location.

The PCS 1110 may prepare to setup a session between the AS 1112 and the PINE/WTRU. The procedure for establishing the session (1140) may include the PCS 1110 checking the PINE related policy and updating the PINE/WTRU profile to indicate that the PINE 1102 has left the PIN. The PCS 1110 may initiate a 5GS PDU session setup/modification procedure through NEF. After the completion of the 5GS related procedure, the PCS may send a ResumeSC_5GS command to the AS (1112) (1142). To be able to resume service continuity, the AS 1112 may be provided with one or more of the PINE/WTRU identifier, the PINE IP address, the PIN port number, the Session ID, and the context token.

After receiving the configuration information, the AS 1112 may resume SC with the PINE 1102 by: changing the PEGC-S ID to the 5G UPF end point identifier, changing to new port # provided by the PINE 1102, including the PINE address in the packet header, using the session ID to identify the buffer, and using the packet marker to release the buffer and resume service.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A wireless transmit/receive unit (WTRU) comprising:
a transceiver; and
a processor,
wherein the transceiver and the processor are configured to receive a service continuity message from a source personal Internet-of-Things (IoT) network (PIN) gateway client (PEGC) that provides connectivity with a PIN element (PINE) for an identified service, wherein the source PEGC has lost connectivity with the PINE,
wherein the transceiver and the processor are further configured to identify a target PEGC for the PINE, and
wherein the transceiver and the processor are further configured to send a configuration message to the target PEGC to configure the target PEGC to provide service continuity for the identified service for the PINE.

2.-5. (canceled)

6. The WTRU of claim 1, wherein the source PEGC and the target PEGC provide connectivity between the PINE and a 5G Core Network (CN).

7.-9. (canceled)

10. The WTRU of claim 1, wherein the WTRU is a PIN management client (PEMC).

11. (canceled)

12. (canceled)

13. A method, implemented in a wireless transmit/receive unit (WTRU), the method comprising:
receiving a service continuity message from a source personal Internet-of-Things (IoT) network (PIN) gateway client (PEGC) that provides connectivity with a PIN element (PINE) for an identified service, wherein the source PEGC has lost connectivity with the PINE;
identifying a target PEGC for the PINE; and
sending a configuration message to the target PEGC to configure the target PEGC to provide service continuity for the identified service for the PINE.

14.-17. (canceled)

18. The method of claim 13, wherein the source PEGC and the target PEGC provide connectivity between the PINE and a 5G Core Network (CN).

19.-21. (canceled)

22. The method of claim 13, wherein the WTRU is a PIN management client (PEMC).

23. (canceled)

24. (canceled)

25. The WTRU of claim 1, wherein the service continuity message includes information that indicates an identifier of the PINE, an internet protocol (IP) address of the source PEGC, an identifier of the identified service, an identifier of an application session the source PEGC was facilitating, and an identifier of an application server that provides the identified service.

26. The WTRU of claim 25, wherein the configuration message includes information that indicates the identifier of the PINE, an identifier of a PIN the PINE is associated with, the identifier of the application server, the identifier of the identified service, and the identifier of the application session.

27. The WTRU of claim 25, wherein the transceiver and the processor are further configured to send an update request message, to a PIN server, to inform the application server that service continuity for the PINE shall be through the target PEGC.

28. The WTRU of claim 27, wherein the update request message includes information that indicates the identifier of the PINE, an identifier of the target PEGC, the IP address of the source PEGC, and the identifier of the application session.

29. The WTRU of claim 1, wherein the PINE comprises a plurality of PINEs associated with the same PIN.

30. The WTRU of 1, wherein the PINE is an Internet-of-Things (IoT) device.

31. The method of claim 13, wherein the WTRU hosts a PIN management client (PEMC).

32. method of claim 13, wherein the WTRU hosts a PIN management client (PEMC).

33. The method of claim 13, wherein the service continuity message includes information that indicates an identifier of the PINE, an internet protocol (IP) address of the source PEGC, an identifier of the identified service, an identifier of an application session the source PEGC was facilitating, and an identifier of an application server that provides the identified service.

34. The method of claim 33, wherein the configuration message includes information that indicates the identifier of the PINE, an identifier of a PIN the PINE is associated with, the identifier of the application server, the identifier of the identified service, and the identifier of the application session.

35. The method of claim 33, further comprising sending an update request message, to a PIN server, to inform the application server that service continuity for the PINE shall be through the target PEGC.

36. The method of claim 35, wherein the update request message includes information that indicates the identifier of the PINE, an identifier of the target PEGC, the IP address of the source PEGC, and the identifier of the application session.

37. The method of claim 13, wherein the PINE comprises a plurality of PINEs associated with the same PIN.

38. The method of 13, wherein the PINE is an Internet-of-Things (IoT) device.
